(19) United States
(12) Patent Application Publication
(10) Pub. No.: US 2018/0056988 A1
(43) Pub. Date: Mar. 1, 2018

(54) VEHICLE REMOTE STARTER SAFETY SYSTEM

(71) Applicant: Ford Global Technologies, LLC, Dearborn, MI (US)

(72) Inventor: Charles W. Heil, JR., Novi, MI (US)

(21) Appl. No.: 15/244,933

(22) Filed: Aug. 23, 2016

(51) Int. Cl. B60W 30/06; G05D 1/00; G05D 1/02; B60R 1/00; B60W 50/00; E05F 15/70; E05F 15/77; G06K 9/00

(52) U.S. Cl. CPC B60W 30/06; E05Y 2900/106; G05D 1/0246; B60R 1/00; B60W 50/0098; E05F 15/70; E05F 15/77; G06K 9/00805; B60W 2420/42; B60W 2550/10; B60W 2600/00; B60W 2710/0677; B60W 2750/40; B60R 2300/8086; G05D 1/0088

(57) ABSTRACT

Apparatus and methods are disclosed for a vehicle remote starter safety system. An example disclosed vehicle includes range detection sensors and an autonomy unit. The example autonomy unit, in response to receiving a start signal, confirms, via the range detection sensors, that a garage door of a garage in which the vehicle is located is open, starts an engine of the vehicle, and autonomously maneuvers the vehicle out of a garage until a tailpipe of the vehicle is outside the garage.

### TECHNICAL FIELD

The present disclosure generally relates to remote vehicle starters and, more specifically, a vehicle remote starter safety system.

### BACKGROUND

Vehicles with remote starter systems facilitate a starting the engine of the vehicle with a key fob. Remote starter systems are used warm up the engine, circulate oil, and/or warm up the interior of the vehicle. However, the engine producing carbon monoxide can create an unsafe environment in a confined space.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Apparatus and methods are disclosed for a vehicle remote starter safety system. An example disclosed vehicle includes range detection sensors and an autonomy unit. The example autonomy unit, in response to receiving a start signal, confirms, via the range detection sensors, that a garage door of a garage in which the vehicle is located is open, starts an engine of the vehicle, and autonomously maneuvers the vehicle out of a garage until a tailpipe of the vehicle is outside the garage.

An example disclosed method to autonomously control a vehicle includes, in response to receiving a start signal, confirming, via range detection sensors, that a garage door of a garage in which the vehicle is located is open. The example method also includes starting an engine of the vehicle. Additionally, the example method includes autonomously maneuvering the vehicle out of a garage until a tailpipe of the vehicle is outside the garage.

An example disclosed computer readable medium comprises instructions that, when executed, cause a vehicle to, in response to receiving a start signal, confirm, via range detection sensors, that a garage door of a garage in which the vehicle is located is open. The example instructions also cause the vehicle to start an engine of the vehicle. Additionally, the example instructions cause the vehicle to autonomously maneuver the vehicle out of a garage until a tailpipe of the vehicle is outside the garage.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIGS. 1A and 1B illustrate a vehicle with a remote starter system that operates in accordance with the teachings to of this disclosure.

FIG. 2 is a block diagram of electrical components of the vehicle of FIGS. 1A and 1B.

FIG. 3 is a flowchart of a method to start the vehicle that may be implemented with the electronic components of FIG. 2.

### DETAILED DESCRIPTION OF EXAMPLE EMBODIMENTS

While the invention may be embodied in various forms, they are shown in the drawings, and will hereinafter be described, some exemplary and non-limiting embodiments, with the understanding that the present disclosure is to be considered an exemplification of the invention and is not intended to limit the invention to the specific embodiments illustrated.

Remote starter systems are electrically coupled to a starter motor of a vehicle. Additionally, remote starter systems wirelessly connect to a key fob or a mobile device (e.g., a smart phone, a smart watch, a tablet, etc.). As used herein, “wireless access device” refers to key fobs and mobile devices that include short-range wireless nodes that are configurable to communicate with the remote starter systems of the vehicle (e.g., through a pairing process). When remote start option is selected (e.g., via a button, via a touch screen input, etc.) on the wireless access device, the remote starter system causes the starter motor to rotate the engine of the vehicle as if the ignition switch had been set to an on position. A vehicle that includes the remote starter system may be an autonomous or semi-autonomous vehicle. A semi-autonomous vehicle is a vehicle that autonomously controls some routine motive functions (e.g., assisted parking, remote assisted parking, adaptive cruise control, etc.). An autonomous vehicle is a vehicle that autonomously controls the motive functions of the vehicle without direct user steering input.

As disclosed herein below, in response to receiving a command to remotely start the vehicle, an autonomy unit coupled to the remote starter system determines whether the vehicle is in a garage. If the vehicle is in the garage, the autonomy unit determines whether a garage door is open. A garage door controller may open the garage door in response to receiving a message from the wireless access device or a message from the autonomy unit. Based on data from a camera and/or range detection sensors, the autonomy unit controls the vehicle to exit the garage until a tailpipe of the vehicle is outside of the garage. The autonomy unit sends a message to notify the wireless access device on whether it successfully maneuvered the vehicle. The autonomy unit may not successfully maneuvered the vehicle if, for example, the garage door does not open or an object (such as another vehicle) obstructs the path of the vehicle.

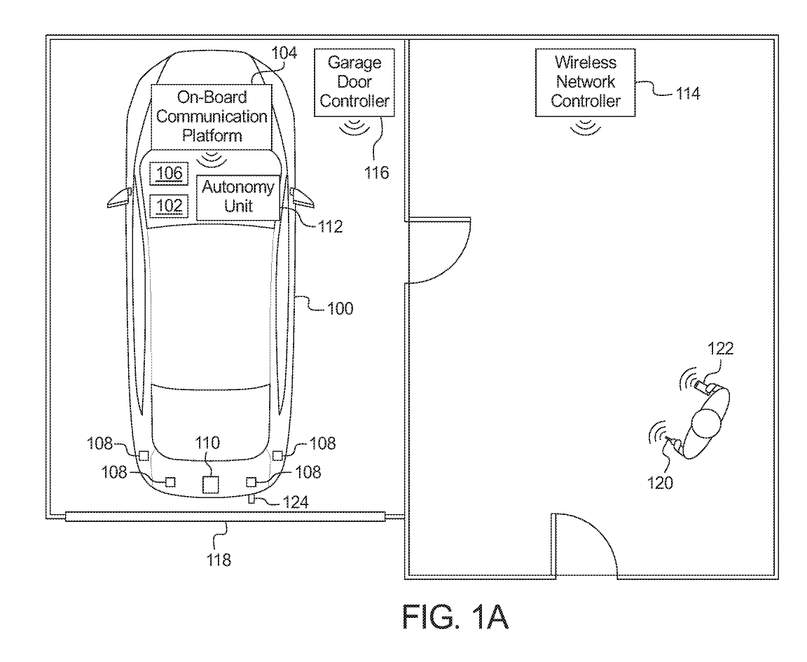

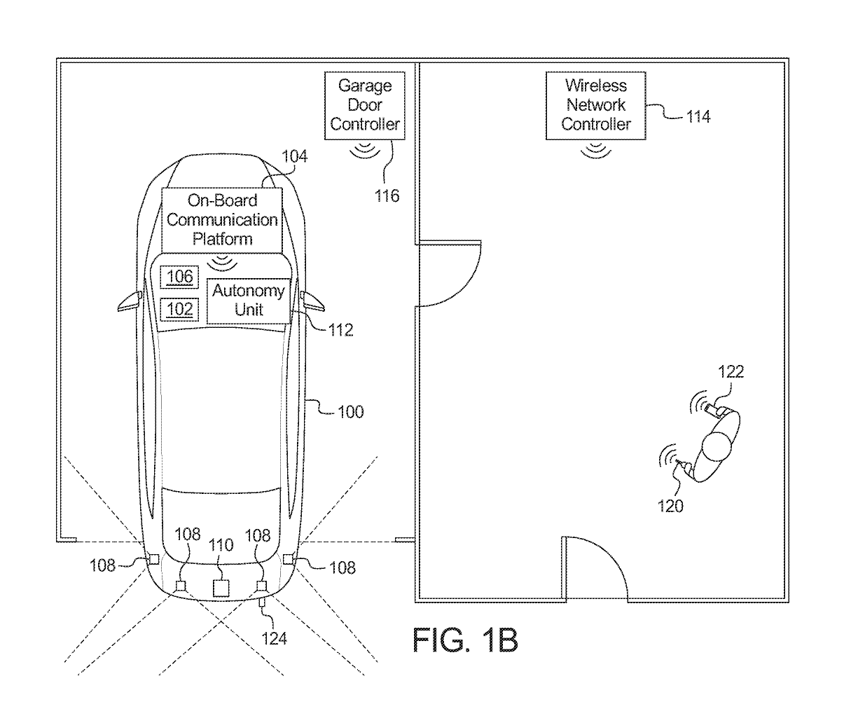

FIGS. 1A and 1B illustrate a vehicle 100 with a remote starter system 102 that operates in accordance with the teachings to of this disclosure. The vehicle 100 may be a standard gasoline powered vehicle or a hybrid vehicle. The vehicle 100 includes parts related to mobility, such as a powertrain with an engine, a transmission, a suspension, a driveshaft, and/or wheels, etc. Additionally, the vehicle 100 may be semi-autonomous or autonomous. In the illustrated examples, the vehicle 100 includes an on-board communications platform 104, an odometer 106, range detection sensors 108, a camera 110, and an autonomy unit 112.

The on-board communications platform 104 includes wired and/or wireless network interfaces to enable communication with external networks and devices. The on-board communications platform 104 also includes hardware (e.g., processors, memory, storage, antenna, etc.) and software to control the wired and/or wireless network interfaces. The on-board communications platform 104 may include controllers for Bluetooth® and/or other standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC); local area wireless network (including IEEE 802.11 a/b/g/n/ac or others), and Wireless Gigabit (IEEE 802.11ad), etc.). In some examples, when park in a garage, on-board communications platform 104 connects to a wireless local area network (WLAN) established by a wireless network controller 114.

The on-board communications platform 104 may also include a global positioning system (GPS) receiver. Further, the external network(s) may be a public network, such as the Internet; a private network, such as an intranet; or combinations thereof, and may utilize a variety of networking protocols now available or later developed including, but not limited to, TCP/IP-based networking protocols. In some examples, the on-board communications platform 104 includes an on-board garage door opener (OBGDO) that communicatively couples to a garage door controller 116. The garage door controller 116 controls a position (e.g., open or closed) of a garage door 118. In such examples, the on-board garage door opener is programmed with the security information to send instructions to a paired garage door controller 116 over a target frequency range (e.g., 300 to 400 MHz, etc.). Alternatively, in some examples, the garage door controller 116 and the on-board communications platform 104 are communicatively coupled to the WLAN established by the wireless network controller 114. In such examples, the vehicle 100 may control the garage door 118 via the on-board communications platform 104.

The odometer 106 measures the distance that the vehicle 100 has traveled. For example, the odometer 106 may track wheel rotations and calculate the distance based on the number of wheel rotations and the tire circumference. The range detection sensors 108 detect objects, such as the garage door 118, around the vehicle 100. The range detection sensors 108 include ultrasonic sensors, cameras, infrared sensors, RADAR, and/or LiDAR, etc. The range detection sensors 108 are embedded in the bumper of the vehicle 100. Alternatively, in some examples, the range detection sensors 108 may be positioned in other locations (e.g., on the roof of the vehicle 100, etc.). In the illustrated example, the camera 110 captures images behind the vehicle 100. In some examples, the camera 110 may be used to detect objects in place of or in conjunction with the range detection sensors 108. Additionally, the vehicle 100 may include cameras 110 that capture images behind the vehicle 100, in front of the vehicle 100 and/or the sides of the vehicle 100.

The autonomy unit 112 controls at least some of the motive functions of the vehicle 100. To control the motive functions of the vehicle 100, the autonomy unit 112 is communicatively coupled to electronic control units (ECUs) that operate the motive subsystems of the vehicle 100, such as a brake control unit, a throttle control unit, and/or a transmission control unit. Additionally, the autonomy unit 112 is communicatively coupled to the odometer 106, the range detection sensors 108, and the camera 110 to facilitate the autonomy unit 112 characterizing the area around the vehicle 100.

The autonomy unit 112 detects a start signal from a key fob 120 and/or a mobile device 122 (e.g., wireless access devices) to the remote starter system 102. In some examples, the key fob 120 and/or the mobile device 122 sends a message to the remote starter system 102 (e.g., via an antenna coupled to the remote starter system 102). When the signal strength of the key fob 120 and/or the mobile device 122 may not powerful enough to reach the vehicle 100 in the garage from within a house, in some examples, the key fob 120 and/or the mobile device 122 is connects to the WLAN controlled by the wireless network controller 114. In such examples, the key fob 120 and/or the mobile device 122 send the start signal via the WLAN. Alternatively, in some examples, a user uses voice commands with a device (e.g. a mobile device 122, an internet appliance such as Echo from Amazon®, etc.) that includes a digital assistant (e.g. Siri® from Apple®, Cortana® from Microsoft®, Alexa from Amazon®, etc.) to send the start signal to the vehicle 100. In some examples, the key fob 120 and/or the mobile device 122 sends an open signal to the garage door controller 116 to open the garage door 118 when it sends the start signal. In some examples, the garage door controller 116 is communicatively couple to the on-board communications platform 104, the key fob 120, and/or the mobile device 122 via the wireless network controller 114. In some examples, the autonomy unit 112, in response to detecting the start signal from the key fob 120 and/or the mobile device 122, sends the open signal to the garage door controller 116 via the on-board garage door opener.

FIG. 1A illustrates the vehicle 100 in the garage with the garage door 118 closed. In response to detecting the start signal to the remote starter system 102, the autonomy unit 112 determines whether the garage door 118 is open using the range detection sensors 108 and/or the camera 110. For example, the autonomy unit 112 may determine whether there is an obstruction behind the vehicle. In some examples, if the garage door 118 is closed, the autonomy unit 112 sends the open signal to the garage door controller 116 via the on-board garage door opener. If the garage door 118 continues to be closed, the autonomy unit 112 sends an error notification to the key fob 120 and/or the mobile device 122. In some examples, the notification includes an image captured by the camera 110.

If the garage door 118 is open, the autonomy unit 112 moves the vehicle 100 until a tailpipe 124 of the vehicle 100 is outside of the garage. While moving the vehicle 100, the autonomy unit 112 continues to monitor for obstructions (e.g., another vehicle, etc.) behind the vehicle 100. If another obstruction prevents the autonomy unit 112 from maneuvering the vehicle 100 so that the tailpipe 124 is outside of the garage, the autonomy unit 112 (a) sends the error notification to the key fob 120 and/or the mobile device 122, and (b) turns off the engine. In some examples, the vehicle 100 detects objects lodged behind a tire outside the view of the range detection sensors 108 and/or the camera 110. For example, the autonomy unit 112 may detect, via wheel speed sensors (not shown), when the speed of one of the wheels is affected by an obstruction (e.g., the wheel speed sensors indicate a difference in acceleration between the wheels). In such examples, when such an object is detected, the autonomy unit 112 (a) sends the error notification to the key fob 120 and/or the mobile device 122, and (b) turns off the engine. The autonomy unit 112 determines when the tailpipe 124 is outside of the garage based on (a) traversing a measured distance (measured via the range detection sensors 108) between the rear of the vehicle 100 and the garage door 118 and/or (b) detecting the boundaries of the garage via the via the range detection sensors 108. FIG. 1B illustrates the vehicle 100 with the tailpipe 124 outside of the garage. In some examples, when the tailpipe 124 outside of the garage, the autonomy unit 112 turns off the engine of the vehicle 100 after a threshold period of time (e.g., two minutes, five minutes, etc.) Additionally, in some such examples, the autonomy unit 112 sends a notification to the key fob 120 and/or the mobile device 122 indicating that the engine is shut off.

In some examples, the mobile device 122 includes an application that communicates with the garage door controller 116 and the vehicle 100. In such examples, the mobile device 122, the garage door controller 116, and the vehicle 100 are communicatively coupled via the WLAN controlled by the wireless network controller 114. In some such examples, the application is only operable when the mobile device 122 is connected to the same WLAN as the garage door controller 116. When activated by a user, the application sends the open signal to the garage door controller 116 and the start signal to the vehicle 100. In some examples, the application includes an interface to view images from the camera 110 as the vehicle 100 is autonomously maneuvering out of the garage.

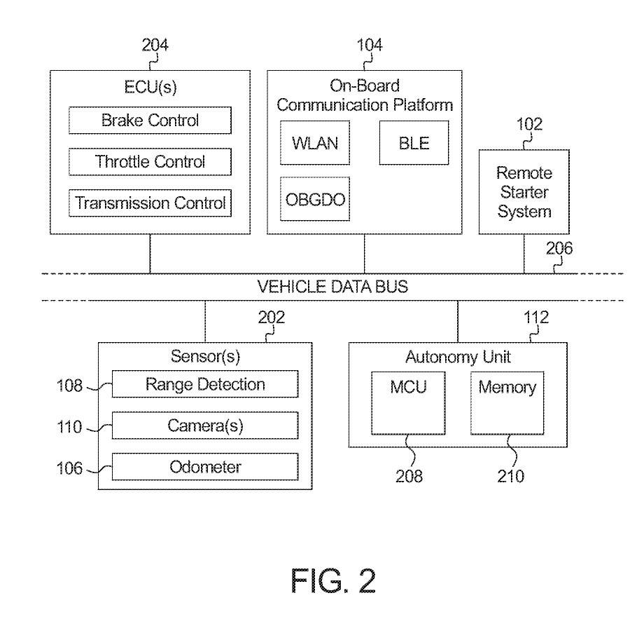

FIG. 2 is a block diagram of electrical components 200 of the vehicle 100 of FIGS. 1A and 1B. In the illustrated example, the electrical components 200 include the remote starter system 102, the on-board communications platform 104, the autonomy unit 112, sensors 202, ECUs 204, and a vehicle data bus 206.

The autonomy unit 112 includes a processor or controller 208, and memory 210. The processor or controller 208 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 210 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 210 includes multiple kinds of memory, particularly volatile memory and non-volatile memory.

The memory 210 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 210, the computer readable medium, and/or within the processor 208 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 202 may be arranged in and around the vehicle 100 in any suitable fashion. The sensors 202 may include camera(s), sonar, RADAR, LiDAR, ultrasonic sensors, optical sensors, or infrared devices configured to detect obstructions around the exterior of the vehicle 100. Additionally, some sensors 202 may be mounted inside the cabin of the vehicle 100 or in the body of the vehicle 100 (such as, the engine compartment, the wheel wells, etc.) to measure properties in the interior of the vehicle 100. For example, such sensors 202 may include accelerometers, odometers, tachometers, pitch and yaw sensors, wheel speed sensors, microphones, tire pressure sensors, and biometric sensors, etc. In the illustrated example, the sensors 202 include the odometer 106, the range detection sensors 108, and the camera 110.

The ECUs 204 monitor and control the subsystems of the vehicle 100. The ECUs 204 communicate and exchange information via a vehicle data bus (e.g., the vehicle data bus 206). Additionally, the ECUs 204 may communicate properties (such as, status of the ECU 204, sensor readings, control state, error and diagnostic codes, etc.) to and/or receive requests from other ECUs 204. Some vehicles 100 may have seventy or more ECUs 204 located in various locations around the vehicle 100 communicatively coupled by the vehicle data bus 206. The ECUs 204 are discrete sets of electronics that include their own circuit(s) (such as integrated circuits, microprocessors, memory, storage, etc.) and firmware, sensors, actuators, and/or mounting hardware. In the illustrated example, the ECUs 204 include a brake control unit, a throttle control unit, and a transmission control unit. The brake control unit includes actuators to operate the brakes of the vehicle 100 so the autonomy unit 112 can activate the brakes without driver input. Additionally, the throttle control unit is capable of adjusting the throttle position of the vehicle 100 so that the autonomy unit 112 can increase the speed of the vehicle 100 without driver input. The transmission control unit facilitates changing the transmission setting of the vehicle 100 so that the autonomy unit 112 can shift into different gears (e.g., reverse, park, etc.) without driver input.

The vehicle data bus 206 communicatively couples the remote starter system 102, the on-board communications platform 104, the autonomy unit 112, the sensors 202 and the ECUs 204. In some examples, the vehicle data bus 206 includes one or more data buses. The vehicle data bus 206 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7), a K-line bus protocol (ISO 9141 and ISO 14230-1), and/or an Ethernet™ bus protocol IEEE 802.3 (2002 onwards), etc.

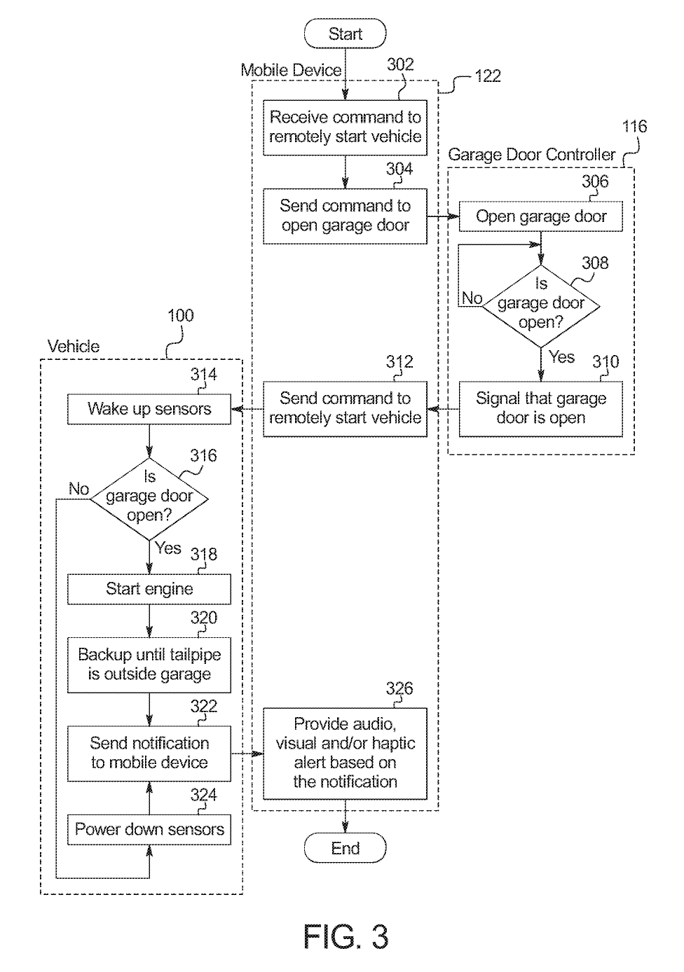

FIG. 3 is a flowchart of a method to start the vehicle 100 that may be implemented with the electronic components 200 of FIG. 2. Initially at block 302, the key fob 120 and/or the mobile device 122 receives a command remotely start the vehicle 100. At block 304, the key fob 120 and/or the mobile device 122 sends the open signal to the garage door controller 116. At block 306, the garage door controller 116 opens the garage door 118. At block 308, the garage door controller 116 waits until the garage door 118 is open. At block 310, the garage door controller 116 sends a message that the garage door 118 is open.

At block 312, the key fob 120 and/or the mobile device 122 sends the start signal to the vehicle 100. At block 314, the autonomy unit 112 wakes up the sensors 202 (e.g., the odometer 106, the range detection sensors 108 and/or the camera 110, etc.). At block 316, the autonomy unit 112, via the sensors 202, determines whether the garage door 118 is open. For example, the garage door controller 116 may have received a close signal between the garage door being opened and the vehicle 100 receiving the start signal, or the garage door controller 116 may been malfunctioning. If the garage door 118 is open, the method continues at block 318. Otherwise, if the garage door 118 is closed, the method continues at block 324.

At block 318, the autonomy unit 112 starts the engine of the vehicle 100. At block 320, the autonomy unit 112 maneuvers the vehicle 100 until the tailpipe 124 is outside the garage. At block 322, the autonomy unit sends a notification to the key fob 120 and/or the mobile device 122. At block 324, the autonomy unit 112 powers down the sensors 202. At block 326, the key fob 120 and/or the mobile device 122 provides an audio, visual and/or haptic alert to the user based on the notification. For example, if the autonomy unit 112 successfully maneuvered the vehicle 100, the notification may include a positive indicator. As another example, if the autonomy unit 112 did not successfully maneuver the vehicle 100 (e.g., because the garage door 118 was not opened, because there was another obstruction in the path of the vehicle 100, etc.), the notification may include a negative indicator and/or a picture of the obstruction taken by the camera 110.

The flowchart of FIG. 3 is representative of machine readable instructions that comprise one or more programs that, when executed by a processor (such as the processor 208 of FIG. 2), cause the vehicle 100 to implement the example autonomy unit 112 of FIGS. 1A, 1B, and 2. Further, although the example program(s) is/are described with reference to the flowchart illustrated in FIG. 3, many other methods of implementing the example autonomy unit 112 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
range detection sensors; and
an autonomy unit to, in response to receiving a start signal:
confirm, via the range detection sensors, that a garage door of a garage in which the vehicle is located is open;
start an engine of the vehicle; and
autonomously maneuver the vehicle out of a garage until a tailpipe of the vehicle is outside the garage.

2. The vehicle of claim 1, including a rear-facing camera, and wherein, in response to detecting an obstruction behind the vehicle, the autonomy unit is to send a notification to a mobile device, the notification to include an image captured by the camera.

3. The vehicle of claim 1, including a rear-facing camera, and wherein the autonomy unit is to stream images captured to by the rear-facing camera to a mobile device when autonomously maneuvering the vehicle out of the garage.

4. The vehicle of claim 1, including an on-board garage door opener that communicatively couples to a garage door controller, and wherein, in response to detecting that the garage door is closed, the autonomy unit is to instruct the garage door controller to open the garage door.

5. The vehicle of claim 1, including an on-board communications platform, and wherein, in response to detecting that the garage door is closed, the autonomy unit is to instruct a garage door controller to open the garage door via a wireless local area network.

6. The vehicle of claim 1, including an on-board communication platform, and wherein the autonomy unit is to receive a second signal to activate the autonomously maneuvering of the vehicle out of the garage via a wireless local area network.

7. The vehicle of claim 1, wherein the autonomy unit is to shut off the engine of the vehicle after a threshold period of time.

8. A method to autonomously control a vehicle comprising:
in response to receiving a start signal, confirming, via range detection sensors, that a garage door of a garage in which the vehicle is located is open;
starting an engine of the vehicle; and
autonomously maneuvering, with an autonomy unit, the vehicle out of a garage until a tailpipe of the vehicle is outside the garage.

9. The method of claim 8, including, in response to detecting an obstruction behind the vehicle, sending a notification to a mobile device, the notification to include an image captured by a rear-face camera on the vehicle.

10. The method of claim 8, including streaming images captured to by a rear-facing camera to a mobile device when autonomously maneuvering the vehicle out of the garage.

11. The method of claim 8, including, in response to detecting that the garage door is closed, instructing a garage door controller to open the garage door via an on-board garage door opener.

12. The method of claim 8, including, in response to detecting that the garage door is closed, instructing a garage door controller to open the garage door via a wireless local area network.

13. The method of claim 8, including receiving a second signal to activate the autonomously maneuvering of the vehicle out of the garage via a wireless local area network.

14. The method of claim 8, including shutting off the engine of the vehicle after a threshold period of time.

15. A computer readable medium comprising instructions that, when executed, cause a vehicle to:
in response to receiving a start signal, confirm, via range detection sensors, that a garage door of a garage in which the vehicle is located is open;
start an engine of the vehicle; and
autonomously maneuver, with an autonomy unit, the vehicle out of a garage until a tailpipe of the vehicle is outside the garage.

16. The computer readable medium of claim 15, wherein the instructions, when executed cause the vehicle to, in response to detecting an obstruction behind the vehicle, send a notification to a mobile device, the notification to include an image captured by a rear-face camera on the vehicle.

17. The computer readable medium of claim 15, wherein the instructions, when executed cause the vehicle to stream images captured to by a rear-facing camera to a mobile device when autonomously maneuvering the vehicle out of the garage.

18. The computer readable medium of claim 15, wherein the instructions, when executed cause the vehicle to, in response to detecting that the garage door is closed, instruct a garage door controller to open the garage door via an on-board garage door opener.

19. The computer readable medium of claim 15, wherein the instructions, when executed cause the vehicle to, in response to detecting that the garage door is closed, instruct a garage door controller to open the garage door via a wireless local area network.

20. The computer readable medium of claim 15, wherein the instructions, when executed cause the vehicle to receive a second signal to activate the autonomously maneuvering of the vehicle out of the garage via a wireless local area network.
